(19) United States
(12) Patent Application Publication
(10) Pub. No.: US 2009/0005974 A1
(43) Pub. Date: Jan. 1, 2009

(54) Fuel cost predictor system

(75) Inventors: John K. Lenneman, Okemos, MI (US); Joseph F. Szczerba, Grand Blanc, MI (US); Roy J. Mathieu, Rochester Hills, MI (US); William C. Barley, Royal Oak, MI (US); Thomas A. Seder, Northville, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/770,927

(22) Filed: Jun. 29, 2007

(51) Int. Cl. G01C 21/34

(52) U.S. Cl. 701/209

(57) ABSTRACT

A vehicle navigation system that provides one or more route choices based on various factors that will reduce travel cost, particularly fuel cost. A fuel cost predictor algorithm weights the various factors to determine the most cost effective route. The factors can include anything that affects fuel and/or vehicle costs, such as distance traveled, driving conditions, such as temperature, snow, ice, etc., fuel prices along the route, terrain, vehicle diagnostics, traffic congestion, driver operating behavior, desired arrival time, rare traffic events, average speed, etc.

### BACKGROUND OF THE INVENTION

1. Field of the Invention

This invention relates generally to a vehicle route determination system that provides route choices based on cost and, more particularly, to a vehicle navigation system that provides one or more routes to choose from based on fuel cost savings, where the system considers a number of factors, such as distance traveled, driving conditions, fuel prices, terrain, traffic, etc.

2. Discussion of the Related Art

Vehicle navigation systems are known in the art that identify and map vehicle routes using GPS signals and map databases. For example, a vehicle operator may input a destination address or location into the navigation system, either expressly or from a saved list, and the system will use the map database and the position of the vehicle from the GPS signals to determine suitable routes to the destination from the current vehicle position. Typically, the navigation system will display a number of route choices that the vehicle operator can select from, such as routes based on shortest distance, fastest travel time, easiest travel, etc. It may be desirable to provide a vehicle navigation system that also determines one or more route choices based on fuel cost.

### SUMMARY OF THE INVENTION

In accordance with the teachings of the present invention, a vehicle navigation system is disclosed that provides one or more route choices based on various factors that will reduce travel cost, particularly fuel cost. A fuel cost predictor algorithm weights the various factors to determine the most cost effective route or routes. The factors can include anything that affects fuel and/or vehicle costs, such as distance traveled, driving conditions, such as temperature, snow, ice, etc., fuel prices along the route, terrain, vehicle diagnostics, traffic congestion, driver operating behavior, desired arrival time, average speed, rare traffic events, etc.

Additional features of the present invention will become apparent from the following description and appended claims taken in conjunction with the accompanying drawings.

### BRIEF DESCRIPTION OF THE DRAWINGS

FIG. 1 is a plan view of a vehicle including a navigation system that determines vehicle routes based on cost savings, according to an embodiment of the present invention;

FIG. 2 is a diagram showing two routes provided by the navigation system of the invention, where the longer route provides greater fuel cost savings; and

FIG. 3 is a block diagram of a system for determining cost saving routes based on a number of factors, according to an embodiment of the present invention.

### DETAILED DESCRIPTION OF THE EMBODIMENTS

The following discussion of the embodiments of the invention directed to a system and method for determining cost effective routes in a vehicle navigation system is merely exemplary in nature, and is in no way intended to limit the invention or its applications or uses.

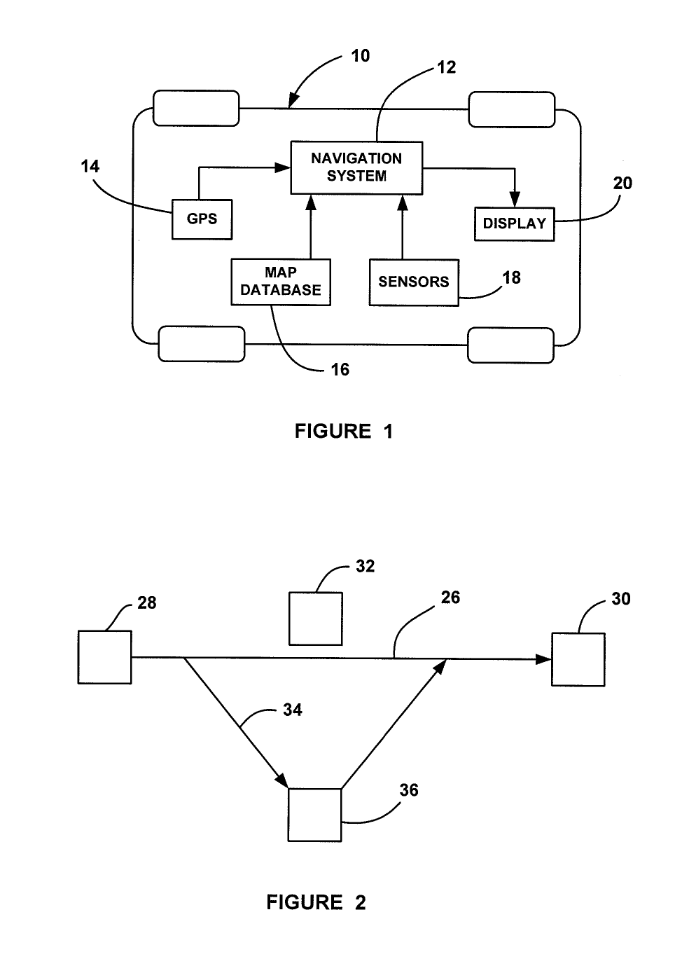

FIG. 1 is a plan view of a vehicle 10 including a navigation system 12. The navigation system 12 receives GPS signals from a GPS receiver 14 and map information from a map database 16. The navigation system 12 can also receive information and transmissions from other suitable sources, such as vehicle stability control sensors, XM radio frequency band, cellular telephone signals, TV band, etc., represented generally here as sensors 18. The navigation system 12 can determine travel routes based on a desired destination that are displayed on a display 20 in a manner that is well understood in the art.

According to the invention, the navigation system 12 of the invention provides an option for one or more routes that are determined based on cost, usually the route or routes that will cost the least amount of fuel. This is not necessarily the route that would use the least amount of fuel, but would be the route that costs the least based on what fuel is used. This can be illustrated by FIG. 2 where it shows a most direct route 26 from a current vehicle position 28 to a destination 30, i.e., the shortest distance. Fuel sold at fuel stations 32 along the route 26 would average a certain price per gallon. Also shown is a less costly route 34 where the fuel from fuel stations 36 along the route 34 would cost less than the fuel from the fuel stations 32, and thus could provide a less costly trip, although it may take more time to travel. Fuel prices can vary dramatically in a relatively small area. Thus, for longer trips usually involving refueling, it may be cheaper to take a less direct route if the price of fuel at the refueling stations on that route is lower.

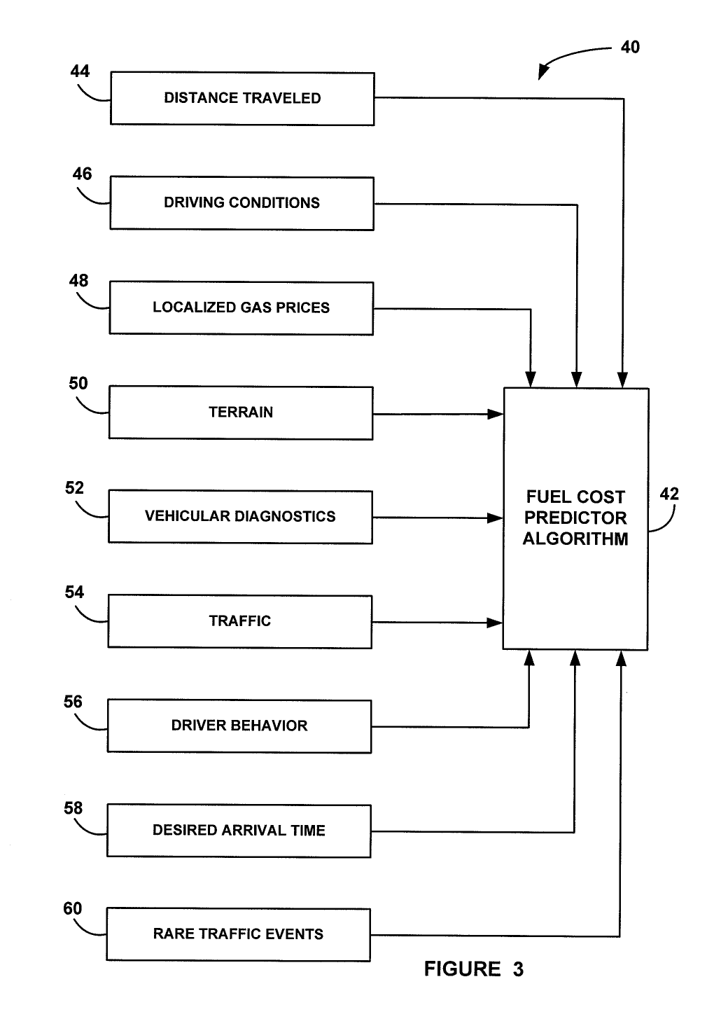

FIG. 3 is a block diagram of a system 40 showing various factors that may go into determining the least costly route by the navigation system 12. The various factors considered are sent to a fuel cost predictor algorithm processor 42 that uses algorithms that weight each of the various factors, so that the navigation system 12 can determine a route or routes that may be less costly. The factors discussed below are not intended to be a comprehensive list in that other factors not specifically identified can be considered for fuel cost savings. The navigation system 12 could display one or more of the available routes from the current vehicle position to the destination on the display 20, and provide a visual indication of the estimate of the cost and proposed time for each route so as to allow the vehicle operator to make a route determination much in the same way that the vehicle operator could determine a route based on fastest drive time or shortest distance.

A distance traveled box 44 determines the distance that is to be traveled from the current vehicle position to the destination, and sets a parameter for the distance traveled as the shortest distance typically being the most cost effective.

A driving condition box 46 uses real-time driving condition information that may be available from a number of different sources to determine what type of environments the vehicle will be traveling through over the various available routes. Various factors go into determining the driving conditions, such as the temperature along the routes, whether the roads will be icy, snowy or wet, the altitude of the various available routes, the barometric pressure along the routes, and other weather conditions. This information can be received by the navigation system 12 through any suitable system that is available in real time, such as FM broadcast, TV band broadcast, satellite transmissions, cellular telephone, etc.

Further, the algorithm also determines fuel prices along the various available routes at box 48. Fuel prices can vary significantly through small geographic areas, and for long distances where refueling may be necessary, the price of fuel between the vehicle position and the destination may significantly affect the route that provides the best cost savings. Fuel price databases are currently being developed that will be continually updated in real time to provide fuel prices in certain geographical areas of the country. These databases may be accessible in many different ways, such as through the Internet, or other types of broadcasts.

The algorithm may also consider the terrain that the vehicle will travel through along the various available routes at box 50. The terrain can use vehicle predictive power train management (PPTM) that considers the effect of traveling along the various available routes on the power train of the vehicle. Further, the algorithm may consider whether the routes are flat or hilly. The PPTM can provide input to the driver for fuel economy purposes, such as taking the driver's foot off the gas pedal when going downhill. Further, the PPTM can provide suggestions and warnings as to fuel economy to notify the driver of wasted fuel.

Further, the algorithm can use vehicle diagnostics at box 52 to help increase cost savings. For example, the various sensors and systems on the vehicle 10 can notify the driver of tire pressure, air filter condition and other factors that would reduce fuel economy so that the driver can make suitable corrections and provide maintenance to reduce the amount of fuel that is used.

The algorithm could also use information about traffic flow, including both real time traffic and historic traffic, along the various available routes at box 54. Depending on a particular day and a particular time of that day, or real time broadcasts of current traffic situations, the algorithm will know whether a particular route will be slow as a result of traffic congestion, and can calculate fuel economy based on that. As is well understood in the art, systems exist that provide real time traffic conditions, such as XM band radio.

Driver behavior can also be considered at box 56. If the driver is driving in a manner that promotes less fuel economy, such as pushing hard on the accelerator, the navigation system 12 can provide a warning or suggestion to the driver, such as on the display 20, to provide better fuel economy. Further, driver behavior is also dictated by speed limits. Two different routes may cause the driver to drive at different average speeds. The algorithm can consider a predicted average speed for different routes when determining the overall fuel costs.

Further, the algorithm considers the desired arrival time at the destination at box 58. The driver may not want to arrive at the destination later than a particular time, which can be input into the system, and would be considered by the algorithm to determine the available routes.

Sometimes rare traffic events occur, such as parades, funeral processions, etc., that do not happen very often, but may have a large impact on traffic. If such information could be captured in a database and be provided real time, then the present invention proposes using that information at box 60 in the algorithm. In one embodiment, the rare traffic event database would include the time of the traffic event, the duration of the traffic event and the magnitude of the traffic event.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A vehicle navigation system comprising:
a plurality of data sources that provide information about conditions along routes from a current vehicle position to a destination; and
a cost predictor algorithm processor that receives the information from the plurality of data sources, and provides one or more routes for a vehicle operator to choose from that are determined based on cost savings.

2. The system according to claim 1 wherein the cost savings are fuel cost savings.

3. The system according to claim 1 wherein the plurality of data sources include broadcasts that are received by the vehicle.

4. The system according to claim 1 wherein the one or more routes are displayed on a display and are identified by cost.

5. The system according to claim 1 wherein one of the plurality of data sources provides information of driving conditions including temperature, road wetness and altitude.

6. The system according to claim 1 wherein one of the plurality of data sources provides fuel prices along the routes.

7. The system according to claim 1 wherein one of the plurality of data sources provides terrain conditions along the routes.

8. The system according to claim 1 wherein one of the plurality of data sources provides real time and/or historic traffic information along the routes.

9. The system according to claim 1 wherein one of the plurality of data sources considers a predicted average speed along the routes.

10. The system according to claim 1 wherein one of the plurality of data sources provides a desired arrival time at the destination.

11. The system according to claim 1 wherein one of the plurality of data sources provides information on rare traffic events.

12. The system according to claim 11 wherein the rare traffic event information includes time of the traffic event, duration of the traffic event and magnitude of the traffic event.

13. The system according to claim 1 wherein one of the plurality of data sources provides information concerning vehicular diagnostics.

14. The system according to claim 1 wherein one of the plurality of data sources considers driver behavior.

15. A vehicle navigation system comprising:
a data source that provides information about fuel prices along several routes from a current vehicle position to a destination; and
a fuel cost predictor algorithm processor that receives the information from the data source, and provides one or more routes for a vehicle operator to choose from that are determined based on cost savings.

16. The system according to claim 15 further comprising a display, wherein the routes are displayed on the display and are identified by the fuel cost for the route.

17. The system according to claim 15 wherein the data source is the internet.

18. A vehicle navigation system comprising:
a driving condition data source that provides weather conditions along one or more routes from a current vehicle position to a destination;
a fuel price data source that provides fuel prices along the routes;
a terrain data source that provides terrain information along the routes;
a traffic information data source that provides traffic flow information along the routes; and
a cost predictor algorithm processor that receives the information from each of the data sources, and displays one or more routes for a vehicle operator to choose from that are determined based on cost savings.

19. The system according to claim 18 further comprising a rare traffic event data source that provides information on rare traffic events.

20. The system according to claim 19 wherein the rare traffic event information includes time of the traffic event, duration of the traffic event and magnitude of the traffic event.

21. The system according to claim 18 wherein further comprising data sources that provide information concerning vehicular diagnostics and driver behavior.

22. The system according to claim 18 further comprising a data source that provides a predicted average speed along different routes.
